(19) United States
(12) Patent Application Publication
(10) Pub. No.: US 2015/0136507 A1
(43) Pub. Date: May 21, 2015

(54) Pedal Assist System

(71) Applicant: Alex Baldwin, Cudahy, WI (US)

(72) Inventor: Alex Baldwin, Cudahy, WI (US)

(21) Appl. No.: 14/541,413

(22) Filed: Nov. 14, 2014

Related U.S. Application Data
(60) Provisional application No. 61/907,089, filed on Nov. 21, 2013.

(51) Int. Cl. B62M 6/00; B62M 1/10

(52) U.S. Cl. CPC B62M 6/00; B62M 1/10
USPC 180/205.1; 60/408

(57) ABSTRACT

The present invention is a piston-actuated bicycle pedal assist system mounted to a bicycle for intermittent assistance with pedaling. This system includes a pedal rotatably attached to a pedal arm. The pedal arm fixedly attaches to a crankshaft such that rotation of the pedal arm and continuous movement of a piston head actuate the crankshaft. A propellant bottle provides propellant flow through propellant tubing. A propellant actuator controls propellant flow into at least one manifold connected to at least one propellant motor cylinder. This manifold includes a check valve that permits one-way propellant flow into the propellant motor cylinder. The check valve alternately opens by the piston head and seals automatically. The piston head includes a piston flap seal reversibly forming a seal that creates a pressure differential within a propellant motor cylinder chamber. This pressure differential controls downward movement of the piston head and an attached piston shaft.

### CROSS-REFERENCE TO RELATED APPLICATIONS

This application claims priority to U.S. Provisional Application No. 61/907,089 filed on Nov. 21, 2013.

### FIELD OF INVENTION

This invention relates to the field of self-propelled vehicles and more specifically to a system for intermittently assisting propulsion.

### BACKGROUND

Many individuals like to use bicycles with battery or electric power sources incorporated in order to reduce effort and fatigue while increasing potential speeds. However, these bicycles may break down if the battery dies, the system malfunctions or for other related reasons. Additionally, many people prefer the physical exertion associated with a traditional bicycle, but may sometimes wish for a degree of assistance when they become overly fatigued or reach an especially steep or rough area.

Devices are known in the prior art that relate to power-assisted bicycles. Some devices provide a power-assisted bicycle with a regenerative brake system that uses an electric motor. Other devices provide a power-assisted bicycle that has a microprocessor for determining the amount of power output necessary to keep the user pedaling at a constant rate. These devices are primarily designed to automatically supplement the energy supplied by the rider, without requiring the rider to act.

For example, a pedelec (from pedal electric cycle) is a bicycle where a small electric motor assists pedaling. Pedelecs include an electronic controller, which stops the motor producing power when the rider is not pedaling or when the rider reaches a certain speed—usually 25 km/h. Pedelecs are useful for people who have to ride in hilly areas or where there are often strong headwinds. Users can convert ordinary conventional bicycles to pedelecs with the addition of the necessary parts, i.e. motor, battery etc.

Several problems are known in the art with respect to electric bicycles. These bicycles are costly to design and difficult to repair. Electric bicycles require mechanical configuration with either sensors or an electronic function that does not require precise speed control. Electric bicycles are bulky and can weigh in excess of forty pounds, making them difficult to carry or store. When the battery drains, then not only is pedaling assistance terminated, but the rider must pedal with significant extra weight on the bicycle.

Accordingly, there have been attempts in the art to replace electric with pneumatic ones. For example, U.S. Pat. No. 4,568,097 teaches a centrifugal air pump in combination with a turbine to pedal a bicycle for a rider. This system does not allow for stored gas or intermittent activation of pedaling assistance. WIPO publication 2006/122333 teaches a bicycle powered by a pneumatic motor, but does not specify a structure for the motor.

There are significant obstacles to creating a pneumatic motor for a bicycle. Pneumatic motors, in particular those on small vehicles such as bicycles, must be capable of providing sufficient propulsion with minimal use of propellant. One problem known in the art is that conventional pneumatic motors waste a significant portion of propellant due to inadequate metal-on-metal piston-chamber seals. Furthermore, because these seals have a high level of friction, motors lose part of the energy provided by propellant. Because small vehicles such as bicycles can only carry a limited amount of propellant, they must be more efficient in propellant use.

It is desirable to develop a bicycle motor system that is simple and lightweight, but also highly efficient.

It is further desirable to develop a bicycle motor system that can provide intermittent pedaling assistance to increase the length of time that it may be used.

### BRIEF DESCRIPTION OF THE DRAWINGS

FIGS. 1a and 1b illustrate a partial back view and a right side view, respectively of an exemplary pedal assist system.

FIGS. 2a and 2b illustrate a magnified partial right side view of an exemplary pedal assist system at different points in a pedaling cycle.

### TERMS OF ART

As used herein, the term “reference axis” means an axis drawn along a frame bracket from the horizontal axis of a crankshaft to the top surface of a bicycle saddle.

### SUMMARY OF THE INVENTION

The present invention is a piston-actuated bicycle pedal assist system mounted to a bicycle for intermittent assistance with pedaling. This system includes at least one pedal rotatably attached to at least one pedal arm. The pedal arm fixedly attaches to at least one crankshaft such that rotation of the pedal arm and continuous movement of a piston head actuate the crankshaft. A propellant bottle provides propellant flow through propellant tubing. A propellant actuator controls propellant flow into at least one manifold connected to at least one propellant motor cylinder. This manifold includes a check valve that permits one-way movement of the propellant flow into the propellant motor cylinder. The check valve alternately opens by the piston head and seals automatically. The piston head includes a piston flap seal reversibly forming a seal. The seal creates a pressure differential within a chamber in the propellant motor cylinder. This pressure differential controls downward movement of the piston head and a piston shaft attached to the piston head. This system may use expansion of compressed gas or combustion to move the piston head and shaft.

### DETAILED DESCRIPTION OF INVENTION

For the purpose of promoting an understanding of the present invention, references are made in the text to exemplary embodiments of a pedal assist system, only some of which are described herein. It should be understood that no limitations on the scope of the invention are intended by describing these exemplary embodiments. One of ordinary skill in the art will readily appreciate that alternate but functionally equivalent components may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale. Instead, emphasis has been placed upon illustrating the principles of the invention. Like reference numerals in the various drawings refer to identical or nearly identical structural elements.

Moreover, the terms “about,” “substantially” or “approximately” as used herein may be applied to modify any quantitative representation that could permissibly vary without resulting in a change in the basic function to which it is related.

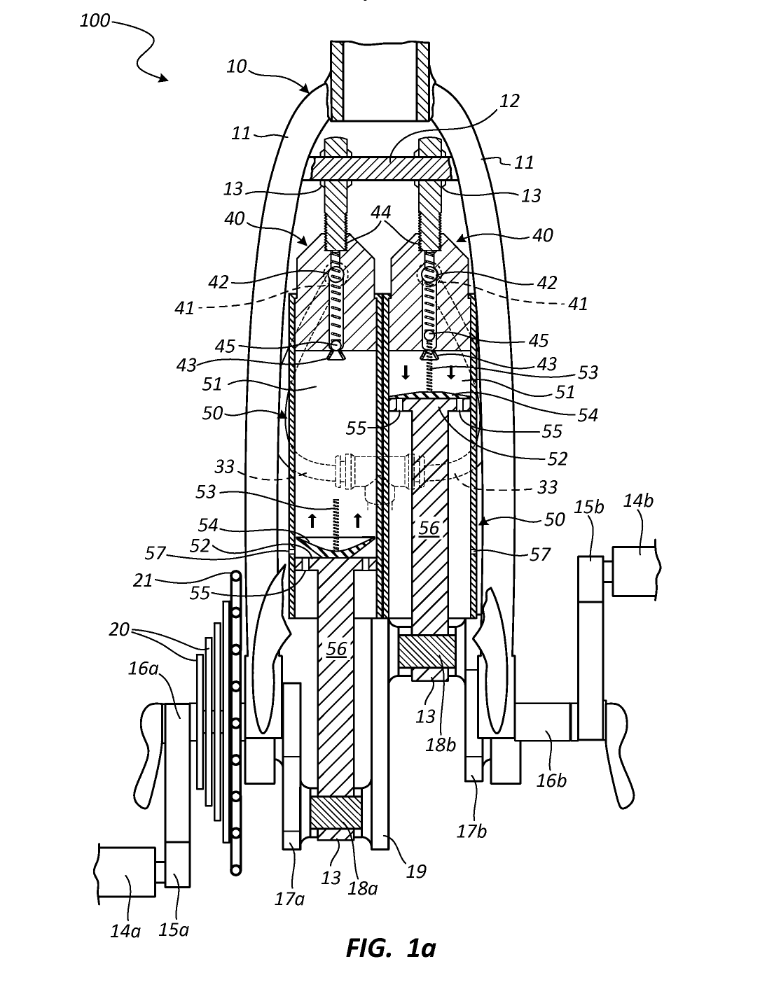

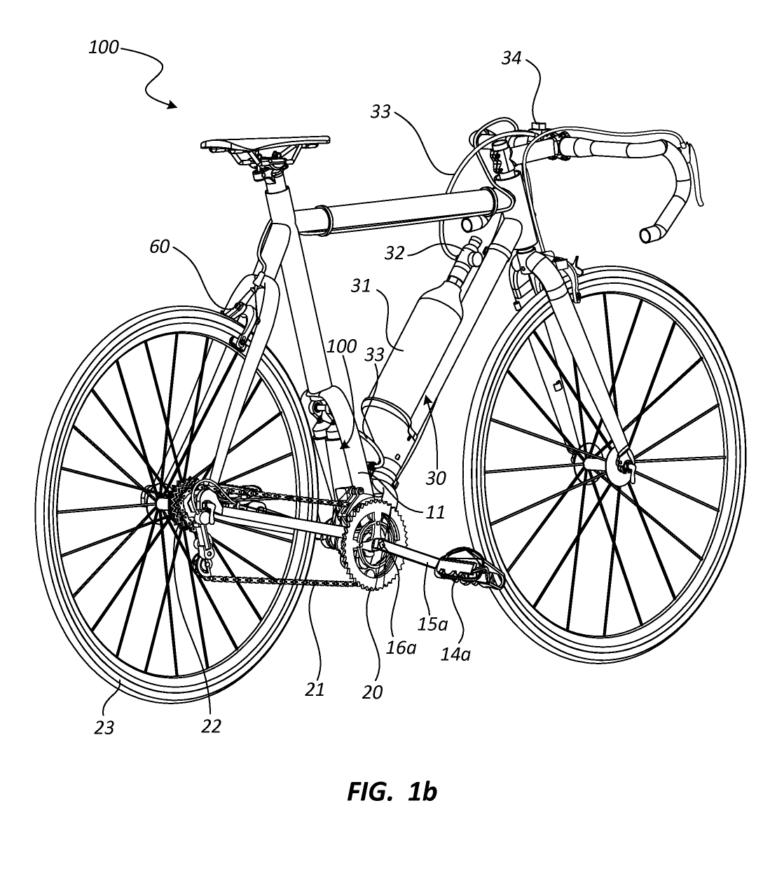

FIGS. 1a and 1b illustrate a partial back view and a right side view, respectively of an exemplary pedal assist system 100. For clarity, FIG. 1a only shows the right side of pedal assist system 100. Pedal assist system 100 includes a bicycle frame assembly 10, a propellant assembly 30, two manifolds 40a and 40b, two propellant motor cylinders 50a and 50b, and an optional regenerative braking system 60. Elements of pedal assist system 100 are constructed from metals such as steel, titanium or aluminum, carbon fiber, polymers, composites, a combination of two or more materials or any other suitable material.

Bicycle frame assembly 10 includes frame bracket 11, a bracket shaft 12, a plurality of rotational fittings 13, two pedals 14a and 14b, two pedal arms 15a and 15b, two crankshafts 16a and 16b, two pedal linkages 17a and 17b, two cylinder shafts 18a and 18b, a shaft linkage 19, a chainring 20, a chain 21, a cassette 22 and a rear wheel 23.

Frame bracket 11 connects bicycle frame assembly 10 to a bicycle B. Frame bracket 11 has an upside-down U-shape and is located between bicycle B and crankshafts 16a and 16b. To optimize hip and knee flexion, most bicycles include a horizontal offset between a location where a rider seats and the locations of crankshafts 16a and 16b. Angling frame bracket 11 at a non-zero angle from vertical accommodates such a horizontal offset. This non-zero angle may range from approximately 1 degree to approximately 25 degrees.

At a first end, frame bracket 11 also supports a bracket shaft 12, which connects to manifolds 40 of propellant motor cylinders 50 via rotational fittings 13. Each rotation fitting 13 rotatably connects bracket shaft 12 at one end and fixedly connects to a manifolds 40 at a second end. Rotation fittings 13 allow manifolds 40 and the connected propellant motor cylinders 50 to pivot about bracket shaft 12. Rotation fittings 13 may be, but are not limited to, rod end bearings, swivel bearings or a clevis fastener.

Two pedals 14a and 14b provide means for motive force input from a rider. Pedals 14a and 14b may be any type of bicycle pedal known in the art. Pedals 14a and 14b rotatably connect to two pedal arms 15a and 15b, respectively. In turn, pedal arms 15a and 15b fixedly connect to the outer ends of two crankshafts 16a and 16b, respectively. Crankshafts 16a and 16b pass through a second end of frame bracket 11, to which crankshafts 16a and 16b rotatably connect. In order to accommodate most riders comfortably, the smallest dimension between pedal arms 15a and 15b can measure no more than 4.8 inches.

The inner ends of crankshafts 16a and 16b fixedly connect to center points of two pedal linkages 17a and 17b, respectively. Each of pedal linkages 17a and 17b rotatably connects to an outer end of cylinder shafts 18a and 18b, respectively. Each of cylinder shafts 18a and 18b connects to one of propellant motor cylinders 50 via rotational fittings 13. Each rotation fitting 13 rotatably connects one of cylinder shafts 18a and 18b at one end and fixedly connects to one of propellant motor cylinders 50 at a second end. Rotation fittings 13 allow propellant motor cylinders 50 to pivot about cylinder shafts 18a and 18b. Shaft linkage 19 fixedly connects the inner ends of cylinder shafts 18a and 18b.

As is common in the art, one of crankshafts 16a and 16b fixedly connects to a chainring 20. In use without activation of pedal assist system 100, a bicycle rider alternately presses down on each pedal 14a or 14b, thereby applying a rotational force to chainring 20. Rotation of chainring 20 moves chain 21 forward, causing cassette 22 to rotate. Because cassette 22 fixes to rear wheel 23, rotation of cassette 22 likewise causes rear wheel 23 to rotate, thereby propelling bicycle B.

Propellant assembly 30 includes a propellant bottle 31, a release valve 32, propellant tubing 33 and a propellant actuator 34. Elements of propellant assembly 30 are constructed from steel, aluminum, carbon fiber, polymers, composites or any other suitable material.

Propellant bottle 31 includes a release valve 32 and holds a volume of propellant under pressure. This propellant serves as a power source. Propellant bottle 31 may hold propellants such as, but not limited to, air, carbon dioxide, nitrogen, methane or any liquefied petroleum propellant. When pedal assist system 100 utilizes combustible propellants, combustion is an option. Propellant bottle 31 may be similar or identical to compressed gas cylinders used for paintball or other recreational sports. Propellant bottle 31 may be refillable or single-use.

Release valve 32 connects to propellant tubing 33. Release valve 32 regulates propellant flow and steps down propellant pressure, reducing propellant pressure to a level that will not damage pedal assist system 100. Actuating release valve 32 allows propellant to travel from propellant bottle 31 along propellant tubing 33 until the propellant reaches propellant actuator 34. Because propellant bottle 31 typically mounts to a lower portion of bicycle B, a rider would find difficulty triggering release valve 32 while riding. When not actuated, propellant actuator 34 interrupts the flow of propellant from propellant bottle 31 to manifolds 40. Because propellant actuator 34 typically mounts to an upper portion of bicycle B, such as the handlebars, a user may more easily actuate propellant actuator 34 to permit flow of propellant from propellant bottle 31 to manifolds 40a and 40b.

Each manifold 40a or 40b includes a propellant inlet 41, a manifold passage 42, a propellant outlet 43, a fitting connection 44 and a check valve 45. Each manifold 40a or 40b mounts to and seals a first end of one of propellant motor cylinders 50a or 50b, respectively. Portions of manifolds 40a and 40b are constructed from steel, aluminum, carbon fiber, polymers, composites or any other suitable material. Portions of manifolds 40a and 40b may be integrally constructed or assembled from multiple discrete components. Manifolds 40a and 40b must be capable of receiving propellant while rotating.

Propellant inlet 41 connects to propellant tubing 33, enabling delivery of propellant through manifold passage 42, out propellant outlet 43 and into one of propellant motor cylinders 50a or 50b. Fitting connection 44 provides a connection between manifolds 40a and 40b and a second end of one of rotational fittings 13. In the exemplary embodiment, this connection is a threaded connection. In other embodiments, the connection may be a welded, soldered, adhesive, snap-fit, press-fit, interlocking or integral connection.

Check valve 45 resides within manifold passage 42. When actuated, check valve 45 allows passage of propellant from manifold passage 42, out propellant outlet 43 and into one of propellant motor cylinders 50a or 50b. In the exemplary embodiment, check valve 45 is a ball-and-spring valve. In this embodiment, the spring has a spring constant between approximately 23 g/mm to approximately 133 g/mm. In this embodiment, the spring is a helical spring, sized so that the ratio between spring and ball diameter ranges from approximately 0.40 to approximately 0.85. In other embodiments, check valve 45 may be a diaphragm, a swing check valve or a rocker valve similar to an overhead valve used in an internal combustion engine.

Each of propellant motor cylinders 50a and 50b includes a chamber 51, a piston head 52, a piston spring 53, a piston flap seal 54, at least one optional vent opening 55, a piston shaft 56 and an exhaust port 57. Propellant motor cylinders 50a and 50b are single-acting cylinders when pedal assist system 100 is a pneumatic-based system. When pedal assist system 100 is a combustion-based system, then propellant motor cylinders 50a and 50b may be double-acting cylinders. Manifold 40a or 40b fixedly seals chamber 51 at a first end. Piston head 52 and piston flap seal 54 seal chamber 51 at a variable second end. The inner walls of chamber 51 have a low surface texture to reduce friction caused by the movement of piston flap seal 54 along chamber 51.

The size of piston head 52 at least partially closes chamber 51. The ratio between the diameters of piston head 42 and chamber 51 ranges from approximately 0.94469 to approximately 0.99911. Piston spring 53 and piston flap seal 54 attach to a first side of piston head 52. The size of piston spring 53 actuates check valve 45 at a certain point in an up stroke of piston head 52, thereby allowing a bolus of pressurized propellant to enter chamber 51.

This bolus causes piston flap seal 54 to expand on a down stroke of piston head 52. In embodiments that do not include a vent opening 55, piston flap seal 54 creates a seal between the inner wall of chamber 51 and the outer periphery of piston head 52. In embodiments that do include at least one vent opening 55, piston flap seal 54 creates a seal chamber 51 and piston head 52, as well as a seal over vent opening 55.

In an unexpanded shape, piston flap seal 54 resembles a cup having a rim thickness that is thinner than a center point thickness, when measured in cross section. The cup shape forms an angle of between approximately 20 degrees and 40 degrees when measured in cross-section from one side to another. The ratio of overall thickness of piston flap seal 54 to center point thickness ranges from approximately 1.5 to approximately 3.7.

The thinner rim allows piston flap seal 54 to flatten and expand when actuated by propellant pressure. The propellant pressure used to actuate piston flap seal 54 ranges from approximately 30 psi to approximately 120 psi. Piston flap seal 54 is constructed from a non-metallic polymer such as silicone. Any material used to construct piston flap seal 54 must be sufficiently stiff to spring back to its unexpanded state after pressure relief, while also pliable enough to conform to and seal chamber 51 and piston head 52. These materials typically have a Shore A durometer between approximately 20 and approximately 65.

A first end of piston shaft 56 rotatably attaches to a second side of piston head 52. A second end of piston shaft 56 rotatably attaches to a rotational fitting 13, itself attached to a one of cylinder shafts 18a or 18b. Exhaust port 57 lies towards a bottom end of chamber 51. At the end of the down stroke, piston head 52 clears exhaust port 57 and allows exhaustion of propellants.

In certain embodiments, a user may remove and replace manifolds 40a and 40b, and propellant motor cylinders 50a and 50b. This allows a user to replace broken or worn-out parts, or exchange parts adapted for a particular use or tolerance with others adapted to different conditions. A user may remove bracket shaft 12 from frame bracket 11 to free manifolds 40a and 40b, and remove piston shaft 56 from linkage with respective crankshaft 16a or 16b to free propellant motor cylinders 50a and 50b. In additional embodiments using a threaded fitting connection 44, a user can free one of manifolds 40a or 40b from its rotational fitting 13 by rotating manifold 40a or 40b, and its respective propellant motor cylinder 50a or 50b

Certain embodiments also include an optional regenerative braking system 60. This allows pedal assist system 100 to harvest previously wasted energy from bicycle B brakes.

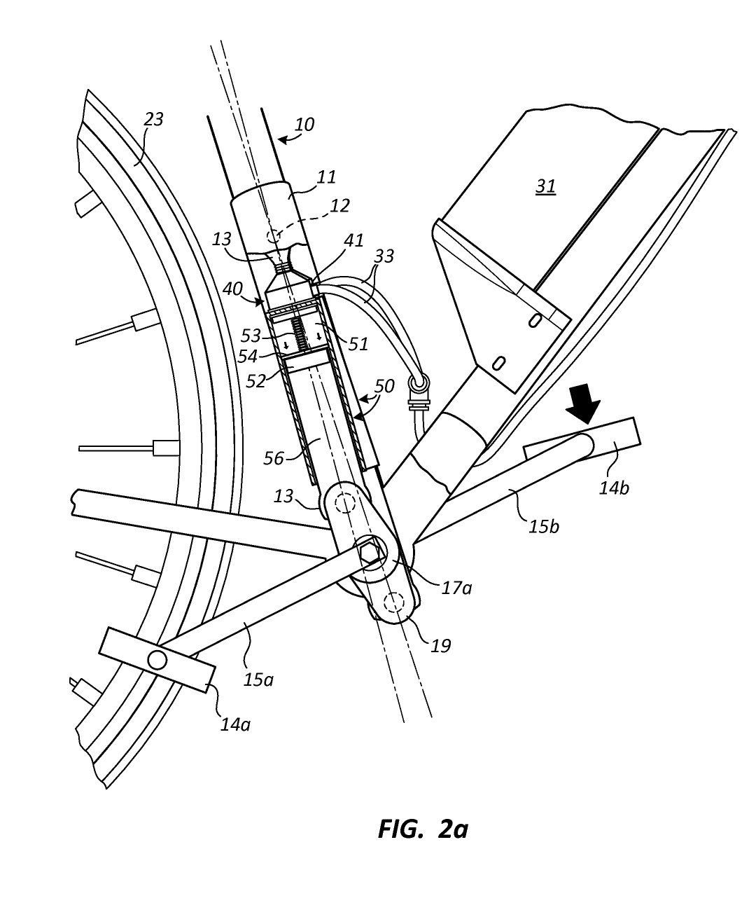

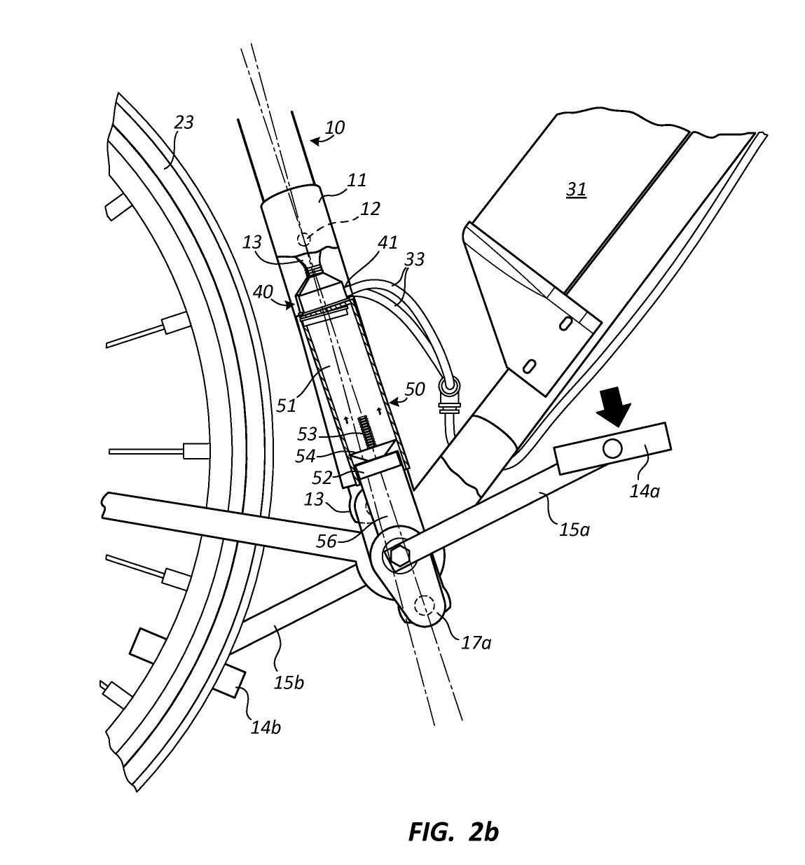

FIGS. 2a and 2b illustrate magnified partial right side views of an exemplary pedal assist system at different points in an exemplary pedaling cycle. In the exemplary pedaling cycle, when piston head 52 comes up to the top of the up stroke, piston spring 53 actuates check valve 45, thereby opening manifold passage 42. The opening of manifold passage 42 forces high pressure propellants into chamber 51, where the propellant pressure expands piston flap seal 54 to seal any vent openings 55 in piston head 52. Once the pressure within chamber 51 equalizes, check valve 45 remains open until the propellant pressure on piston head 52 forces piston head 52 down, removing piston spring 52 from check valve 45 and closing check valve 45. When piston head 52 reaches the bottom of the down stroke, the reduced propellant pressure allows piston flap seal 54 to retract to reduce friction on the next up stroke. Retraction of piston flap seal 54 also allows propellant to escape from propellant vent openings 55 when piston head 52 begins the next up stroke.

One of the key concepts of pedal assist system 100 is the angle of applied power when in use. When the rider is not applying a significant amount of torque, i.e. when each pedal arm 15a and 15b approaches an angle of approximately 70 degrees to approximately 110 degrees with respect to the reference axis, each respective propellant motor cylinder 50a and 50b is at the top of the up stroke, and capable of supplying maximum torque. Likewise, when propellant motor cylinders 50a and 50b are not applying a high amount of torque, the rider is in a position to supply torque. This ensures that torque remains high throughout the pedaling cycle.

Specifically, the particular angle of applied power results from angularly offsetting cylinder shafts 18a and 18b from pedal arms 15a and 15b, respectively, with regard to a central point found at crankshafts 16a and 16b, again respectively. As pedal arms 15a and 15b rotate about the horizontal axes of crankshafts 16a and 16b, respectively, the horizontal axes of cylinder shafts 18a and 18b, also rotate about the horizontal axes of crankshafts 16a and 16b, respectively. However, because pedal arms 15a and 15b have an angular offset of approximately 90 degrees from cylinder shafts 18a and 18b, respectively, pedal assist system 100 applies torque at a point in the pedaling cycle when the rider is not applying a significant amount of torque.

What is claimed is:

1. A piston-actuated bicycle pedal assist system, comprised of:
at least one pedal rotatably attached to at least one pedal arm, wherein said at least one pedal arm is fixedly attached to at least one crankshaft, wherein said at least one crankshaft is actuated by rotation of said at least one pedal arm and by a piston head that moves continuously;
a propellant bottle mounted to said bicycle;
a propellant actuator mounted to said bicycle, wherein said propellant actuator controls propellant flow from said propellant bottle through propellant tubing into at least one manifold connected to at least one propellant motor cylinder mounted to said bicycle,
wherein said at least one manifold comprises a check valve that permits one way movement of said propellant flow into said at least one propellant motor cylinder, wherein said check valve is alternately opened by said piston head and sealed automatically,
wherein said piston head further includes a piston flap seal reversibly forming a seal creating a pressure differential within a chamber within said at least one propellant motor cylinder, wherein said pressure differential controls downward movement of said piston head and a piston shaft attached to said piston head.

2. The system of claim 1 wherein said at least one pedal arm comprises two pedal arms, wherein said at least one crankshaft comprises two crankshafts, wherein a smallest dimension between said two pedal arms is no more than 4.8 inches.

3. The system of claim 1 wherein said at least one pedal arm has an angular offset of approximately 90 degrees from a cylinder shaft.

4. The system of claim 1 wherein said propellant is selected from the group consisting of: air, carbon dioxide, nitrogen, methane, gasoline and liquefied petroleum.

5. The system of claim 1 wherein said propellant actuator is a throttle.

6. The system of claim 1 wherein said propellant actuator is a pressure activated switch.

7. The system of claim 1 wherein said at least one manifold and said at least one propellant motor cylinder connect to a frame bracket located between said bicycle and said at least one crankshaft, wherein said frame bracket is U-shaped.

8. The system of claim 7 wherein said frame bracket forms a non-zero angle from vertical ranging from approximately 1 degree to approximately 25 degrees.

9. The system of claim 7 wherein said at least one manifold rotatably connects to said frame bracket.

10. The system of claim 1 wherein said at least one propellant motor cylinder has a width of no more than 2.4 inches.

11. The system of claim 1 wherein said check valve is selected from the group consisting of: a ball-and-spring valve, a diaphragm, a swing check valve and a rocker valve.

12. The system of claim 11 wherein said check valve is a ball-and-spring valve, wherein said spring has a spring constant between approximately 23 g/mm to approximately 133 g/mm.

13. The system of claim 12 wherein said spring is a helical spring, wherein a ratio between a diameter of said spring and a diameter of said ball ranges from approximately 0.40 to approximately 0.85.

14. The system of claim 1 wherein said piston flap seal comprises a non-metallic polymer having a Shore A durometer between approximately 20 and approximately 65.

15. The system of claim 1 wherein said piston flap seal is cup-shaped, having a rim thickness that is thinner than a center point thickness.

16. The system of claim 15 wherein said piston flap seal has a ratio of overall thickness to center point thickness ranging from approximately 1.5 to approximately 3.7.

17. The system of claim 15 wherein said piston flap seal forms an angle of between approximately 20 degrees and 40 degrees when measured in cross-section from one side to another.

18. The system of claim 15 wherein a pressure of propellant required to actuate said piston flap seal ranges from approximately 30 psi to approximately 120 psi.

19. The system of claim 1 wherein a ratio between the diameters of said piston head and said chamber ranges from approximately 0.94469 to approximately 0.99911.

20. A piston-actuated bicycle pedal assist system, comprised of:
at least one manifold connected to at least one propellant motor cylinder mounted to a bicycle,
wherein said at least one manifold comprises a check valve that permits one way movement of a propellant flow into said at least one propellant motor cylinder, wherein said check valve is alternately opened by a piston head and sealed automatically,
wherein said piston head further includes a piston flap seal reversibly forming a seal creating a pressure differential within a chamber within said at least one propellant motor cylinder, wherein said pressure differential controls downward movement of said piston head and a piston shaft attached to said piston head.
